(19) United States
(12) Patent Application Publication
(10) Pub. No.: US 2006/0210215 A1
(43) Pub. Date: Sep. 21, 2006

(54) Optical transceiver array

(76) Inventors: Shigenori Aoki, Atsugi (JP); Kishio Yokouchi, Tokyo (JP)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 11/081,305

(22) Filed: Mar. 15, 2005

(51) Int. Cl. G02B 6/12

(52) U.S. Cl. 385/14; 385/3

(57) ABSTRACT

A board level optical system for high speed device interconnection is disclosed. A constant intensity laser is mounted on a board substrate, and the laser light is divided into a plurality of optical channels using a waveguide splitter that is integrated into the substrate. An array of high speed optical modulators electrically driven by an IC device mounted on the substrate creates a corresponding plurality of optical signals. A connector is used to transfer the optical signals to one or more other devices, either on or off of the substrate. The optical modulators are preferably Mach Zehnder modulators comprising polymeric electro-optical material. The modulator array may be integrated into the substrate. IC device may also have integrated photodetectors for receiving optical signals routed via the substrate. In addition to optical wiring layers, the substrate may have one or more electrical wiring layers.

### BACKGROUND OF THE INVENTION

1. Field of the Invention

The present invention is related to optical interconnects and is more specifically directed to a high speed optical transceiver array.

2. Background

As computers and communication devices become ever faster and the demand for communication bandwidth increases, there is a corresponding need to increase the speed of connections between the components used in such devices to enable the devices can achieve the desired speed and bandwidth. Conventional electronic circuits are unable to achieve data speeds between components greater than about 10 Gbps over any appreciable distance, such that increasing attention is being directed to optical interconnections. While optical systems can achieve much higher speeds, they are more expensive to fabricate, and this greater expense has been an obstacle to the adoption of optical interconnect expedients.

### SUMMARY OF THE INVENTION

Accordingly, there is a need for improved, lower cost optical interconnect solutions capable of high speed operation.

In one aspect, the present invention comprises an optical transceiver array, having a laser for generating a beam of light, a waveguide divider coupled to the laser for providing a plurality of light signals from said light beam, each of the light signals traveling in a discrete optical channel, a plurality of optical modulators corresponding to the plurality of optical channels, each of the optical modulators being coupled to a driver circuit for providing an electrical signal, such that the electrical signals cause modulation of the light signals in the associated optical channels, and a plurality of output connectors corresponding to said plurality of optical channels, for transferring modulated light signals to another device. The optical transceiver, optical channels and optical modulators are preferably formed on a single substrate and the optical connectors are formed or mounted on said substrate. In preferred embodiments, the electrical signals originate from an integrated circuit device that is flip-chip mounted on said substrate. The integrated circuit device may also have a plurality of photodetectors formed therein for receiving and transducing optical signals. The optical modulators are preferably Mach-Zehnder modulators and comprise polymeric electro-optical material. The substrate may comprise at least one electric wiring layer and an electrical connector, such as an edge connector.

In another aspect, the aforementioned optical transceiver further comprises a second integrated circuit device mounted on said substrate, a plurality of secondary optical channels for receiving said light signals from said plurality of connectors, each of said secondary optical channels being coupled to a photodetector for transducing the light signal in said secondary optical channel into an output electrical signal, wherein output electrical signals are inputted into said second integrated circuit device. The plurality of photodetectors is preferably integrated into the second integrated circuit device. In this embodiment, each of the two integrated circuit devices may have a laser, a waveguide divider, a plurality of modulators, a plurality of connectors and a plurality of photodetectors associated therewith, such that each of said two integrated circuit devices can optically transfer signals to the other. At least one of the integrated circuit devices may be a central processing unit (CPU).

In another aspect, the present invention is directed to an optical transceiver formed on a substrate having an electrical wiring layer and an optical wiring layer, an integrated circuit device, having a plurality of photodetectors associated therewith, flip-chip mounted on the substrate, a constant light intensity laser diode mounted on the substrate, an optical divider for dividing the light emitted by said laser diode into a first plurality of optical channels, a plurality of optical modulators associated with the plurality of optical channels, the optical modulators being electrically coupled to a corresponding plurality of driver circuits associated with the integrated circuit device, such that a plurality of modulated optical output signals corresponding to the electrical signals from the integrated circuit device are generated, a second plurality of optical channels for transmitting modulated light signals to the photodetectors associated with the integrated circuit device, such that electrical signals are formed and inputted to the integrated circuit device. The plurality of driver circuits and the plurality of photodetectors may be integrated in the integrated circuit device.

In yet another aspect, the present invention is directed to a method of optical communication, comprising generating constant intensity light using a laser diode mounted on a substrate, dividing the light from the laser into a plurality of optical channels formed within the substrate, modulating the light in the optical channels using a plurality of driver circuits associated with an integrated circuit device mounted on the substrate to create a plurality of modulated optical output signals, and transmitting the modulated optical output signals to at least one other device. The other device may be mounted either on or off of the substrate.

### BRIEF DESCRIPTION OF THE DRAWINGS

FIG. 1 is a plan view of a first embodiment of the optical transceiver of the present invention.

FIG. 2A is a exploded view of a optical modulator used in connection with the present invention, and FIG. 2B is a more detailed view of the electro-optical layer in the modulator of FIG. 2A.

FIG. 3 is a plan view of a second embodiment of the optical transceiver of the present invention.

FIG. 4 is a plan view of a third embodiment of the optical transceiver of the present invention.

### DETAILED DESCRIPTION

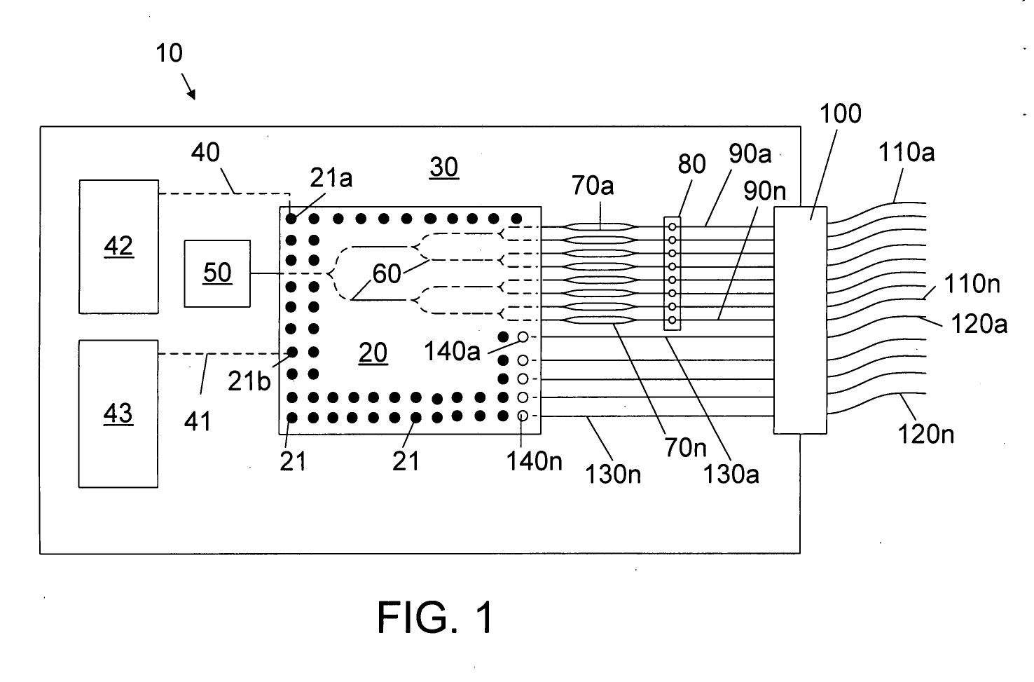

FIG. 1 is a plan view of a first embodiment of the optical transceiver 10 of the present invention. An integrated circuit chip 20 is flip chip mounted on a substrate 30 using a plurality of solder bumps 21. Those skilled in the art will appreciate that the solder bumps used to make connections between substrate 30 and IC device 20 will typically be far more numerous than is depicted, and that for clarity, no bumps are shown in certain areas where there are other structures of interest. Although flip-chip mounting is shown, other methods of making connections between a substrate and a IC chip are well known and are within the scope of the present invention. Flip-chip bonding provides a very high density of connections is a relatively small space and is, therefore, preferred. In a preferred embodiment, integrated circuit chip 20 is a CMOS device formed on silicon.

Substrate 30 preferably is a multilayer substrate that includes one or more electrical wiring layers so that electrical power and signals can be routed to and from IC device 20. Electrical connection paths 40 and 41, embedded within substrate 30, illustrate electrical signals routed between electrical components 42 and 43, respectively, and IC chip 20 via solder bumps 21a and 21b. It will be appreciated that the number of electrical connections will generally be far greater than two. Likewise, while two electrical components are shown in FIG. 1, the number of components mounted on board 30 may be greater.

According to the present invention optical signals are used for high speed, multi-channel signal transfer. In certain prior art designs, an electronic device would have an integrated light emitter for each optical channel. Thus, some known IC devices have a plurality of built-in vertical cavity surface emitting lasers (VCSELs), with a separate VCSEL for each optical channel. The use of a large number of VCSELs, or other integrated light emitting devices, is costly and has made the use of optical signal transmission unattractive. In known devices, each VCSEL is independently driven to provide the desired optical signal in a channel.

Instead of using multiple VCSELs, or other light emitting devices, the present invention uses a relatively higher power laser 50, which provides light for multiple optical channels. As depicted in FIG. 1, laser 50 is preferably separate from IC device 20, and is preferably an edge emitting laser diode. Suitable high power laser diodes in various wavelengths ranges are well known and need not be described in detail. According to the present invention, laser 50 is of the type which has a constant output, such that no signal modulation of the laser is required.

The output of laser 50 is divided into multiple channels using a waveguide splitter 60. While the figures show splitter 60 having eight channels, more channels can be created using known waveguide splitter technology. The light intensity in the channels is, preferably, substantially equal and constant. Because the light intensity in each branch of splitter 60 diminishes as the number of branches is increased, there is a practical limit to how many channels can be fed from one laser diode. If necessary, multiple lasers can be used to increase the number of channels.

Preferably, waveguide splitter 60 is integrated into substrate 30. Thus, as shown, for example, in FIG. 1, splitter 60 is built into substrate 30, with IC device 20 mounted over it. Using current technology a five stage splitter can be fabricated with a length of less than 8 mm, and a final pitch of 0.05 mm. Suitable waveguide splitters and methods of fabricating them are well known in the art and need not be described in further detail.

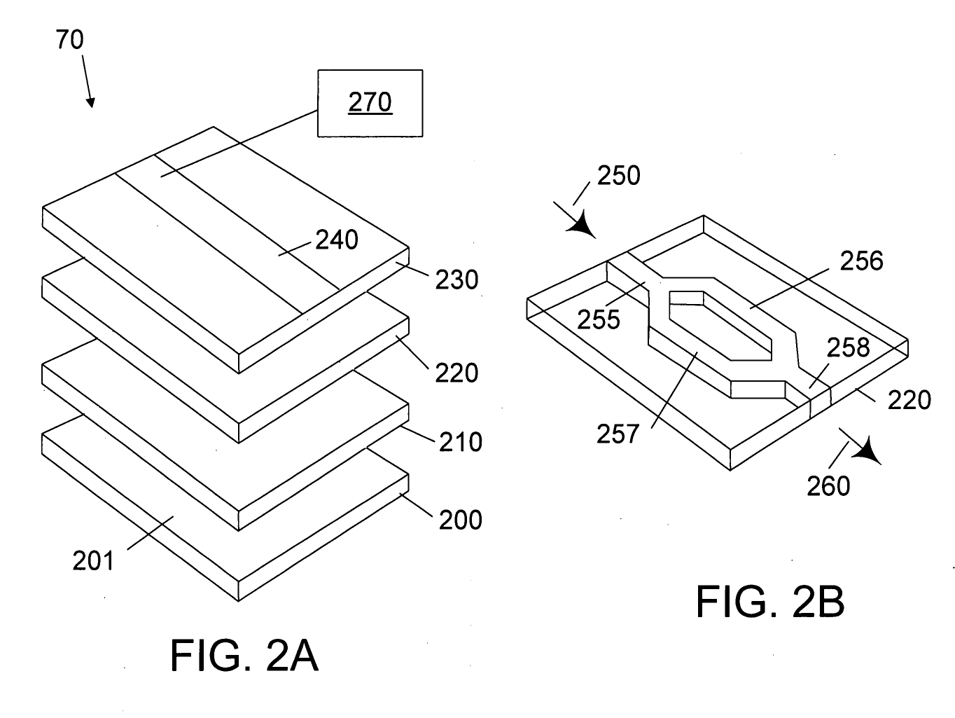

After the light from laser 50 has been divided into a plurality of optical channels, it is directed to a corresponding plurality of optical modulators 70. Electrical signals from device 20 are used to drive modulators 70, transducing the electrical signals into optical signals. Preferably, optical modulators 70 are also integrated into substrate 30 and comprise polymeric electro-optical (“EO”) material. In one embodiment, modulators 70 are Mach-Zehnder modulators. Modulator array 70a-70n may be constructed having a length of 7.5 mm and a pitch of 0.125 mm using current fabrication technology. The construction and operation of an optical modulator 70 of an exemplary embodiment of the present invention is described below in connection with FIGS. 2A and 2B. The compact design of the present invention, whereby the IC device is mounted on the substrate in the immediate area of modulators 70, minimizes the length of the electrical path from the IC chip to the modulators.

The modulated light from optical modulators 70 is then transmitted via a plurality of waveguides 90 formed in substrate 30 to a connector array 100 which transfers the optical signals to at least one other device. In the embodiment of FIG. 1, connector array 100 transfers the optical signals to a plurality of receiving optical fibers 110a-110n in a fiber array 110. The number of waveguides 90, connectors in array 100, and receiving optical fibers in fiber array 110 corresponds to the number of optical channels and optical modulators. Preferably, waveguides 90 are integrated into substrate 30. Suitable connectors for transmitting light from a plurality of on-board waveguides to a corresponding plurality of optical fibers are known and need not be described further. Thus, FIG. 1 depicts a board level system useful for converting electrical signals generated by IC device 20 into optical signals and then transmitting them off of board 30 to one or more other devices (not shown in FIG. 1) via fiber array 110.

Those skilled in the art will appreciate that a terminator array 80 may be used to avoid back reflection of electrical signals into the optical modulators. Various types electrical terminators, and their manner of construction, are well known, and need not be described in further detail.

In the embodiment of FIG. 1, fiber array 110 comprises both a plurality of optical fibers 110a-110n which receive output optical signals, and a plurality of optical fibers 120a-120n, which transfer input optical signals in the reverse direction to device 20. Thus, in FIG. 1, connector array 100 is able to receive light signals from optical fibers 120a-120n, and transfer them to corresponding waveguides 130a-130n formed in substrate 30.

Waveguides 130 lead to a corresponding plurality of optical bumps (not shown), or other structures for coupling light from the waveguides to a corresponding plurality of photodetectors 140 associated with IC device 20. Photodetectors 140 transduce light signals from waveguides 130 into corresponding electrical signals. Preferably, photodetectors 140 are integrated into IC device 20, such that the electrical signals they produce are inputted directly into the device.

In FIG. 1 board 30 is shown having a single IC device 20 mounted thereon which is coupled to optical connector array 100. It will be appreciated multiple devices can be mounted on the same substrate and coupled to a fiber array in this manner.

FIG. 2A is an exploded view of an optical modulator 70 suitable for use in the present invention. Modulator 70 comprises a plurality of layers which are preferably formed on substrate 30 (not shown in FIG. 2A) and which comprise a part of the final substrate. Base layer 200 may be formed of any suitable material. As described above, one or more electrical wiring layers may also be formed on substrate 30. Preferably, such wiring layers are below the base layer 200. Base layer 200 has a ground plane 201 formed on the upper surface thereof. Ground plane 201 may be formed, for example, by depositing a thin layer of gold or other suitable metal on the surface of base layer 201. Ground plane 201 is connected to ground potential by any suitable means. For example, ground plane 201 may be connected by a via to a ground layer in the underlying wiring structure. One function of ground plane 201 is to prevent electrical fields from signals routed in the electrical wiring layers from influencing the EO material used in the modulator.

A lower light confinement or cladding layer 210 is then formed over base layer 200. Lower light layer 210 may be formed from a glass, a polymer or other material which is compatible with the remaining structures. Suitable materials for lower light confinement layer 210, and methods of forming layers of such materials, are well known and need not be described in further detail. Layer 210 can have a thickness in the range of 2-4 microns.

An active modulator layer 220 is then formed over lower light confinement layer 210. Modulator layer 220 is described below in connection with FIG. 2B.

Finally, an upper light confinement or cladding layer 230 is formed over active modulator layer 220. Upper light confinement layer 230 may be formed of materials and in a manner which is similar to lower light confinement layer. Thus, for example, upper light confinement layer may be formed of a glass resin or polymer with a suitable index of refraction. Upper confinement layer may also have a thickness in the range of 2-4 microns, but it is not necessary for upper and lower confinement layers to have the same thickness.

An electrode structure 240 is then formed on upper light confinement layer 230 to control modulation of light in active modulator layer 220. Electrode structure 240 is electrically coupled to an external driver circuit 270 associated with IC device 20. Preferably, driver circuit 270 is integrated into IC device 20. Electrode structure 240 may comprise two electrodes that are connected to driver circuit 270 using solder bumps 21 on IC device 20. This arrangement allows for a very short electrical path and, therefore, effectively reduces parasitic resistance, inductance and capacitance. Electrode structure 240 may comprise a thin layer of gold, or other suitable conductive material, which is patterned using standard and well known photolithographic techniques.

Turning to FIG. 2B, a Mach Zehnder optical modulator is shown in active modulator layer 220. Constant intensity input light 250 from laser 50 is received at the input of the modulator via electro-optical (EO) waveguide channel 255. Channel 255 splits into two branch channels or arms 256 and 257, and the input light is substantially equally divided between the branch channels. After passing through the branch channels, the light is recombined in output waveguide channel 258, and thereafter is transmitted on as output light signal 260. In one embodiment, layer 220 may have a thickness of the order of 2 microns or less, channels 255-258 have widths of 5 microns or less, and the space between branch channels 256 and 257 is about 10 microns or less.

Electrical fields created by electrode structure 240 cause variations in the refractive indices of the EO material in channels 256 and 257. This, in turn, causes relative phase shifting of the light passing through the two branch channels. When the light is recombined, the phase shifted signals interfere, causing modulation in the intensity of output light signal 260. There is an inverse relationship between the length of the branch channels and the necessary driving voltage—the longer the channel the lower the needed voltage—and so there is a design trade off between driver output and compactness of design. The operation of Mach Zehnder optical modulators is well known in the art, and need not be described in further detail. The response time of available EO polymers is less than 1 picosecond, such that operational speeds of over 100 Gbps, perhaps as much as 200 Gbps, can be attained with EO polymer Mach Zehnder modulators. EO modulators made of lithium niobate (LNO) and similar crystal can also be used, but are less preferred because of their slower response time caused by their larger dielectric constant than EO polymer.

Input waveguide channel 255, branch channels 256 and 257, and output waveguide channel 258 are, preferably, all formed of the same EO material, preferably an EO polymer. The remainder of layer 220 is, preferably, formed from a compatible polymer with a suitable index of refraction to confine the light in channels 255-258. Channels 255-258 can be formed by patterning layer 220 using photolithography to create trenches, filling the resulting trenches with a liquid EO polymer, and then curing the polymer. Suitable fabrication techniques for forming such structures are well known in the art.

For illustrative purposes, optical modulator 70 is shown in FIGS. 2A and 2B in isolation. In the preferred embodiments of the present invention, it is integrated, along with the other optical channels, splitters, etc., into the same substrate. Thus, in the preferred embodiments, input and output waveguide channels 255 and 258 do not have facets.

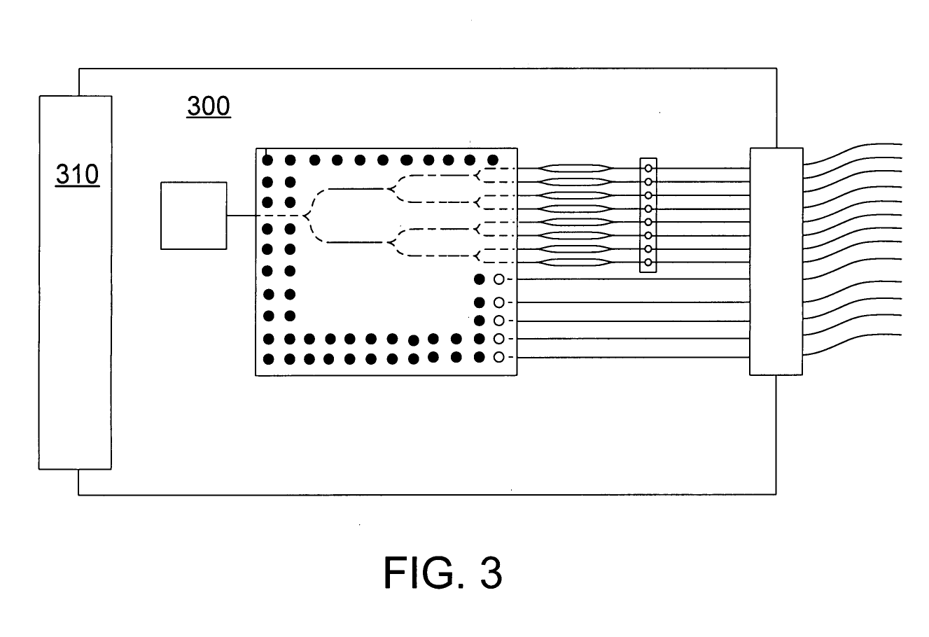

FIG. 3 is an alternate embodiment of the optical transceiver of the present invention, wherein the same numbers are used to depict the same elements described above in connection with FIGS. 1 and 2. The embodiment of FIG. 3 comprises a substrate 300 having an electrical edge connector 310, such that substrate 300 can communicate both optical and electrical signals to and from the board. Edge connector 310 may be a standard connector used in the computer industry. For simplicity, board 300 is shown with only one IC device mounted thereon. It will be understood that a greater number of devices and electrical components can also be mounted on the substrate.

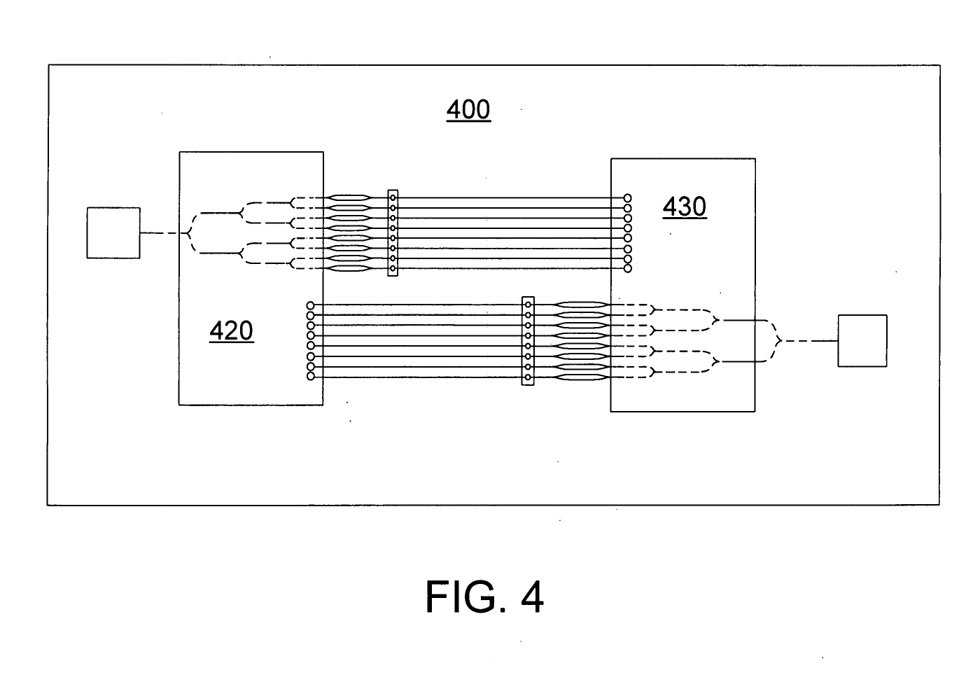

FIG. 4 is yet another alternative embodiment of the optical transceiver of the present invention, again using the same numbers to identify the same elements as the prior figures. The embodiment of FIG. 4 comprises a substrate 400 on which two IC devices, 420 and 430, are mounted. Devices 420 and 430 are optically linked, as depicted, such that each acts as an optical transceiver. Although for simplicity FIG. 4 shows devices 420 and 430 communicating only with each other, it will be appreciated that either or both of the devices can also be coupled, electrically or optically, to any number of other devices, either on or off of board 400, using the structures and techniques previously described.

While the present inventions have been particularly described with respect to the illustrated embodiments, it will be appreciated that various alterations, modifications and adaptations may be made based on the present disclosure, and are intended to be within the scope of the present inventions. While the inventions have been described in connection with what is presently considered to be practical and preferred embodiments, it is to be understood that the invention is not limited to the disclosed embodiments but, on the contrary, is intended to cover various modifications and equivalent arrangements included within the scope of the appended claims.

We claim:

1. An optical transceiver array, comprising:
a laser for generating a constant intensity beam of light,
a waveguide divider coupled to said laser for providing a plurality of constant intensity light signals from said light beam, each of said light signals traveling in a discrete optical channel;
a plurality of optical modulators corresponding to said plurality of optical channels, each of said optical modulators being coupled to a driver circuit associated with an input electrical signal, such that said electrical signal causes modulation of the light signal in the associated optical channel;
a plurality of connectors corresponding to said plurality of optical channels, for transferring said modulated light signals.

2. The optical transceiver of claim 1 wherein said optical channels and said optical modulators are formed on a single substrate.

3. The optical transceiver of claim 2 wherein said optical connectors are formed on said substrate.

4. The optical transceiver of claim 2 wherein said electrical signals originate from an integrated circuit device mounted on said substrate.

5. The optical transceiver of claim 2 wherein said optical modulators comprise electro-optical material.

6. The optical transceiver of claim 5 wherein said optical modulators are Mach-Zehnder modulators.

7. The optical transceiver of claim 2 wherein said substrate comprises at least one electric wiring layer.

8. The optical transceiver of claim 4 further comprising:
a second integrated circuit device mounted on said substrate, and
wherein said connectors comprise a plurality of photodetectors associated with said second integrated circuit for transducing said light signal into an output electrical signal, and said output electrical signals are inputted into said second integrated circuit device.

9. The optical transceiver of claim 8 wherein each of said two integrated circuit devices has a laser, waveguide divider, plurality of modulators, plurality of connector photodetectors associated therewith, such that each of said two integrated circuit devices can optically communicate with the other.

10. The optical transceiver of claim 8 wherein at least one of said integrated circuit devices is a central processing unit (CPU).

11. The optical transceiver of claim 8 wherein said plurality of photodetectors is built into said second integrated circuit device.

12. The optical transceiver of claim 4, wherein said integrated circuit device is flip-chip mounted on said substrate.

13. The optical transceiver of claim 4, wherein said integrated circuit device comprises a plurality of photodetectors coupled to a secondary plurality of optical channels, for transducing optical signals received by said integrated circuit device from said secondary plurality of optical channels into electrical signals.

14. The optical transceiver of claim 2 wherein said substrate comprises an electrical connector.

15. The optical transceiver of claim 14 wherein said electrical connector is an edge connector.

16. A optical transceiver, comprising:
a substrate having an electrical wiring layer and an optical wiring layer,
a integrated circuit device flip-chip mounted on said substrate and having a plurality of photodetectors associated therewith;
a constant light intensity laser diode mounted on said substrate,
an optical divider for dividing the light emitted by said laser diode into a first plurality of optical channels,
a plurality of optical modulators associated with said plurality of optical channels, said optical modulators being electrically coupled to a corresponding plurality of driver circuits associated with said integrated circuit device, such that a plurality of modulated optical output signals corresponding to said electrical signals from said integrated circuit device are generated,
a second plurality of optical channels for transmitting modulated light signals to said photodetectors associated with said integrated circuit device, such that electrical signals are formed and inputted to said integrated circuit device.

17. The optical transceiver of claim 16, wherein said plurality of driver circuits and said plurality of photodetectors are integrated in said integrated circuit device.

18. A method of optical communication, comprising:
generating constant intensity light using a laser diode mounted on a substrate,
dividing the light from said laser into a plurality of optical channels formed within said substrate,
modulating the light in said optical channels using a plurality of driver circuits associated with an integrated circuit device mounted on said substrate to create a plurality of modulated optical output signals,
transmitting said modulated optical output signals to at least one other devices.

19. The method of claim 18 wherein said at least one said other device is mounted on said substrate.

20. The method of claim 18 wherein said at least one other device is mounted off of said substrate.
